(19) United States
(12) Patent Application Publication
(10) Pub. No.: US 2025/0130989 A1
(43) Pub. Date: Apr. 24, 2025

(54) METHOD, APPARATUS, AND COMPUTER PROGRAM PRODUCT FOR IDENTIFYING SPLIT ELECTRONIC DATA RECORDS

(71) Applicant: McKesson Corporation, Irving, TX (US)

(72) Inventors: Gregory Dean, Castle Rock, CO (US); Stephen D. Norris, Henrico, VA (US)

(21) Appl. No.: 18/920,584

(22) Filed: Oct. 18, 2024

Related U.S. Application Data
(60) Provisional application No. 63/544,875, filed on Oct. 19, 2023.

(51) Int. Cl. G06F 16/23; G06F 16/25

(52) U.S. Cl. CPC G06F 16/2365; G06F 16/252

(57) ABSTRACT

A method, apparatus and computer program product provide identification of split electronic records, and temporarily preventing electronic records from being transmitted. Electronic records may be split by a separate system for transmission to various systems and are identified and reconciled. Certain electronic records may be temporarily prevented from being transmitted, to allow for review and/or modification prior to further processing. New electronic records that are unmatched to original electronic records, as well as rejected electronic records, can therefore be reduced, and the related systems are improved accordingly.

### CROSS REFERENCE TO RELATED APPLICATION

This application claims priority to U.S. Application No. 63/544,875, filed Oct. 19, 2023, the entire contents of which are hereby incorporated by reference in its entirety.

### TECHNOLOGICAL FIELD

Embodiments of the present disclosure relate generally to electronic data records, and more particularly, to methods, apparatuses, and computer program products for identifying split electronic data records.

### BACKGROUND

Modern computing systems are often implemented in a distributed system to provide for efficiency and reuse of certain modules, algorithms, and the like. Various components and/or subsystems of a distributed system can transmit data in a different format than a format from what it is received, such that the various components and subsystems should be integrated in a way that supports data integrity and the communication of accurate data amongst the components and subsystems. Additional systems can be implemented over time and can be integrated with the distributed system, providing a greater complexity and challenges pertaining to data compatibility and data integrity.

Such integration can introduce several complexities and technical challenges due to the various systems involved in processing data and routing data amongst various components. For example, some systems may have compatibility constraints and/or database constraints that cause data to be manipulated in a manner that creates data mismatches, duplication of data, and/or violation of data rules in other components of a distributed system.

### BRIEF SUMMARY

The ordering and distribution of medical supplies relies on the communication of data between numerous sub-systems. For example, some distributed systems include a service provider system that operates at least in part as a portal for home health agencies (HHA)s to submit electronic records representative of medical supply orders and to check the status of such electronic records. The distributed system further facilitates the submission of such orders to a supplier system to perform additional billing processes with a payer system, such as one affiliated with a commercial insurance plan or other payer of medical claims. The supplier system forwards orders to a distributor system to handle the distribution of medical supplies to patents. Distributed systems automate several aspects of the ordering, billing, and fulfillment process, but introduce several complexities and technical challenges due to the various systems involved in processing such an order, as well as due to the volume of orders processed in a given time period. The various problems can arise in and impact different components of the network. For example, some payer systems may provide coverage for only certain products or quantities of certain supplies, such that claims and orders are often rejected and returned to various systems in the network, including but not limited to the supplier system, service provider system, and home health agencies, creating an extra burden with regard to the computer processing resources and memory resources needed to facilitate correction and/or resubmission of an order via the various systems. When only a portion of an order quantity is covered by insurance, the order quantity is reduced and a new order generated and communicated throughout the system. The new order processed and communicated by the various components, consumes additional processing, memory, and network resources, and also creates an unmatched order that is unreconciled with the originally placed order.

An apparatus is provided, comprising at least one processor and at least one memory including computer program code, the at least one memory and the computer program code configured to, with the at least one processor, cause the apparatus to at least receive, from a first system of a first type, an electronic record comprising one or more first entity identifiers, and one or more product identifiers and associated quantities, and access an electronic record system to obtain first entity information and second entity information.

The computer program code is configured to, with the at least one processor, cause the apparatus to reformat the electronic record to further include at least the first entity information and the second entity information in the electronic record, and cause transmission of the electronic record to a routing system, wherein the routing system (i) determines one or more systems of a second type to which to route the electronic record, and (ii) routes the electronic record to the one or more systems of a second type.

The computer program code is configured to, with the at least one processor, cause the apparatus to receive a plurality of electronic record response messages from the routing system, the plurality of electronic record response messages comprising at least an electronic record number and an identifier of the one or more systems of a second type, reconcile the plurality of electronic record response messages with the received electronic record, and provide an electronic record status interface indicating electronic records statuses and the determined one or more systems of a second type.

The computer program code is configured to, with the at least one processor, cause the apparatus to identify a split electronic record comprising a plurality of sub-records in the plurality of electronic record response messages, correlate the split electronic record comprising the plurality of sub-records to an originally submitted electronic record, and provide the plurality of sub-records via the electronic record status interface.

The at least one memory and the computer program code are further configured to, with the at least one processor, cause the apparatus to at least generate a rule configuration comprising one or more conditions relating to an electronic record, electronically provide the rule configuration to the first system and facilitate approval of the rule configuration, and in response approval of the rule configuration, cause transmission of the approved rule configuration to the routing system, wherein the approved rule configuration affects the determination of the one or more systems of a second type dependent on the one or more conditions.

The at least one memory and the computer program code are further configured to, with the at least one processor, cause the apparatus to at least indicate, to a system of a third type, a temporary electronic record hold, wherein the electronic record is prevented from being distributed for at least a predetermined amount of time, and enable cancellation of the electronic record via, at least a supply management system, for the predetermined amount of time.

The at least one memory and the computer program code are further configured to, with the at least one processor, cause the apparatus to at least determine at least one sub-record of the split electronic records is cancelled, and in response thereto, generate a new electronic record comprising a quantity based on one or more non-cancelled electronic records.

The at least one memory and the computer program code are further configured to, with the at least one processor, cause the apparatus to at least indicate in the electronic record status interface at least two sub-records associated with a single product, wherein quantities of the at least two sub-records equal a quantity electronic recorded of the single product. Different systems of a second type are selected for each of at least two electronic records based on a determination of a limited quantity of a product covered by second entity.

A method is provided, comprising receiving, from a first system of a first type, an electronic record comprising one or more first entity identifiers, and one or more product identifiers and associated quantities, accessing an electronic record system to obtain first entity information and second entity information, and with one or more processors, reformatting the electronic record to further include at least the first entity information and the second entity information in the electronic record. The method further includes causing transmission of the electronic record to a routing system, wherein the routing system (i) determines one or more systems of a second type to which to route the electronic record, and (ii) routes the electronic record to the one or more systems of a second type, receiving a plurality of electronic record response messages from the routing system, the plurality of electronic record response messages comprising at least an electronic record number and an identifier of the one or more systems of a second type, and reconciling the plurality of electronic record response messages with the received electronic record.

The method further includes providing an electronic record status interface indicating electronic record statuses and the determined one or more systems of a second type, identifying a split electronic record comprising a plurality of sub-records in the plurality of electronic record response messages, correlating the split electronic record comprising the plurality of sub-records to an originally submitted electronic record, and providing the plurality of sub-records via the electronic record status interface.

The method may further include generating a rule configuration comprising one or more conditions relating to an electronic record, electronically providing the rule configuration to the first system and facilitate approval of the rule configuration, and in response approval of the rule configuration, causing transmission of the approved rule configuration to the routing system, wherein the approved rule configuration affects the determination of the one or more systems of a second type dependent on the one or more conditions.

The method further includes indicating, to a system of a third type, a temporary electronic record hold, wherein the electronic record is prevented from being distributed for at least a predetermined amount of time, and enable cancellation of the electronic record, via at least a supply management system, for the predetermined amount of time. The method further includes determining at least one sub-record of the split electronic records is cancelled, and in response thereto, generate a new electronic record comprising a quantity based on one or more non-cancelled electronic records.

The method includes indicating in the electronic record status interface at least two sub-records associated with a single product, wherein quantities of the at least two sub-records equal a quantity electronic recorded of the single product.

A computer program product is provided comprising at least one non-transitory computer-readable storage medium having computer-executable program code instructions stored therein, the computer-executable program code instructions comprising program code instructions to receive, from a first system of a first type, an electronic record comprising one or more first entity identifiers, and one or more product identifiers and associated quantities, access an electronic record system to obtain first entity information and second entity information, and reformat the electronic record to further include at least the first entity information and the second entity information in the electronic record.

The computer-executable program code instructions comprising program code instructions to cause transmission of the electronic record to a routing system, wherein the routing system (i) determines one or more systems of a second type in a network to which to route the electronic record, and (ii) routes the electronic record to the one or more systems of a second type, and receive a plurality of electronic record response messages from the routing system, the plurality of electronic record response messages comprising at least an electronic record number and an identifier of the one or more systems of a second type.

The computer-executable program code instructions comprising program code instructions to reconcile the plurality of electronic record response messages with the received electronic record, provide an electronic record status interface indicating electronic record statuses and the determined one or more systems of a second type, identify a split electronic record comprising a plurality of sub-records in the plurality of electronic record response messages, correlate the split electronic record comprising the plurality of sub-records to an originally submitted electronic record, and provide the plurality of sub-records via the electronic record status interface.

The computer-executable program code instructions further comprise program code instructions to generate a rule configuration comprising one or more conditions relating to an electronic record, electronically provide the rule configuration to the first system and facilitate approval of the rule configuration, and in response approval of the rule configuration, cause transmission of the approved rule configuration to the routing system, wherein the approved rule configuration affects the determination of the one or more systems of a second type dependent on the one or more conditions.

The computer-executable program code instructions further comprise program code instructions to indicate, to a system of a third type, a temporary electronic record hold, wherein the electronic record is prevented from being distributed for at least a predetermined amount of time, and enable cancellation of the electronic record via, at least a supply management system, for the predetermined amount of time.

The computer-executable program code instructions further comprise program code instructions to determine at least one sub-record of the split electronic records is cancelled, and in response thereto, generate a new electronic record comprising a quantity based on one or more non-cancelled electronic records.

The computer-executable program code instructions further comprise program code instructions to indicate in the electronic record status interface at least two sub-records associated with a single product, wherein quantities of the at least two sub-records equal a quantity electronic recorded of the single product.

An apparatus is provided, including means for receiving, from a first system of a first type, an electronic record comprising one or more first entity identifiers, and one or more product identifiers and associated quantities, means for accessing an electronic record system to obtain first entity information and second entity information, and means for reformatting the electronic record to further include at least the first entity information and the second entity information in the electronic record. The apparatus further includes means for causing transmission of the electronic record to a routing system, wherein the routing system (i) determines one or more systems of a second type to which to route the electronic record, and (ii) routes the electronic record to the one or more systems of a second type, receiving a plurality of electronic record response messages from the routing system, the plurality of electronic record response messages comprising at least an electronic record number and an identifier of the one or more systems of a second type, and means for reconciling the plurality of electronic record response messages with the received electronic record.

The apparatus further includes means for providing an electronic record status interface indicating electronic record statuses and the determined one or more systems of a second type, means for identifying a split electronic record comprising a plurality of sub-records in the plurality of electronic record response messages, means for correlating the split electronic record comprising the plurality of sub-records to an originally submitted electronic record, and means for providing the plurality of sub-records via the electronic record status interface.

The apparatus may further include means for generating a rule configuration comprising one or more conditions relating to an electronic record, electronically providing the rule configuration to the first system and facilitate approval of the rule configuration, and in response approval of the rule configuration, means for causing transmission of the approved rule configuration to the routing system, wherein the approved rule configuration affects the determination of the one or more systems of a second type dependent on the one or more conditions.

The apparatus further includes means for indicating, to a system of a third type, a temporary electronic record hold, wherein the electronic record is prevented from being distributed for at least a predetermined amount of time, and enable cancellation of the electronic record, via at least a supply management system, for the predetermined amount of time. The apparatus further includes means for determining at least one sub-record of the split electronic records is cancelled, and in response thereto, means for generating a new electronic record comprising a quantity based on one or more non-cancelled electronic records.

The apparatus further includes means for indicating in the electronic record status interface at least two sub-records associated with a single product, wherein quantities of the at least two sub-records equal a quantity electronic recorded of the single product.

The above summary is provided merely for purposes of summarizing some example embodiments of the disclosure so as to provide a basic understanding of some aspects of the disclosure. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the disclosure in general terms, reference will now be made to the accompanying drawings, which are not necessarily drawn to scale, and wherein:

FIG. 1 illustrates a workflow relating to the ordering of medical supplies;

FIG. 2 is a schematic diagram of a distributed system;

FIG. 3 is a schematic diagram of an improved distributed system according to certain embodiments;

FIG. 4 is an example user interface of the improved distributed system according to certain embodiments;

FIG. 5 is an exemplary schematic diagram of an apparatus in accordance with some example embodiments; and

FIGS. 6-8 are flowcharts of operations that may be performed in accordance with some example embodiments.

### DETAILED DESCRIPTION

Some embodiments of the present disclosure will now be described more fully hereinafter with reference to the accompanying drawings, in which some, but not all embodiments are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, where a computing device is described to receive data from another computing device, it will be appreciated that the data may be received directly from the other computing device and/or may be received indirectly via one or more intermediary computing devices, such as, for example, one or more servers, relays, routers, network access points, and/or the like. Similarly, where a computing device is described herein to transmit data to another computing device, it will be appreciated that the data may be sent directly to the other computing device or may be sent to the other computing device via one or more interlinking computing devices, such as, for example, one or more servers, relays, routers, network access points, and/or the like.

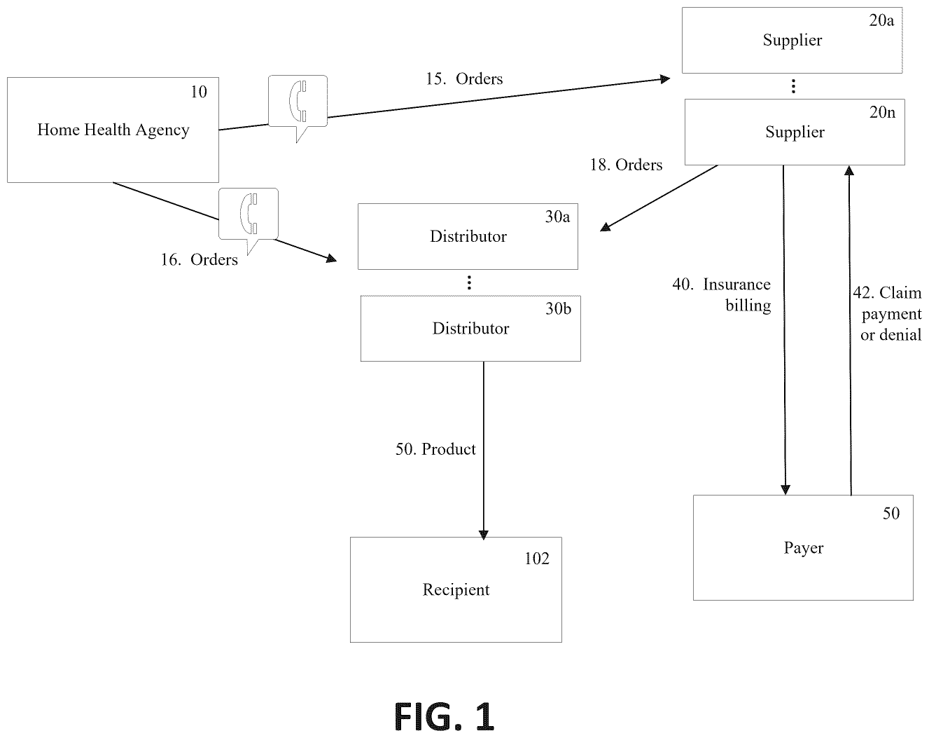

FIG. 1 is a diagram illustrating a workflow relating to the ordering of home medical equipment and/or medical supplies. The term ‘medical equipment’ often refers to durable medical equipment and/or medical equipment intended for re-use such as but not limited to wheelchairs, walkers, home hospital beds, and/or the like. The term ‘medical supplies’ may include medical products intended for temporary or one-time use such as but not limited to gauze, bandages, needles, syringes, and/or the like. With regard to a home health agency (HHA) ordering such medical equipment and/or medical supplies on behalf of a patient for in-home use, the ordering, distribution, billing, and associated workflows and processes may be similar such that the term ‘medical supplies’ and/or ‘medical equipment’ as referenced herein may be considered to include any combination of medical equipment, durable medical equipment, medical supplies, and/or the like. The terms ‘medical supplies’ and/or ‘medical equipment’ may therefore be used interchangeably herein. It will also be appreciated that certain embodiments, operations and processes described herein may apply to the ordering, billing, distribution and/or supply of any type of product and are therefore not limited to medical supplies.

In the medical equipment marketplace, there are limited choices for a HHA and the patients they serve. An HHA, such as HHA 10 in FIG. 1 may send orders (15) to a supplier, and/or send orders (16) to a distributor. A home medical equipment (HME) supplier may be additionally or alternatively referred to as a ‘DME’ as shorthand for DME supplier (Durable Medical Equipment) supplier, or simply a ‘supplier.’ The suppliers, such as suppliers 20a-20n handle insurance billing 40 to the payer 50, whereas a distributor, such as distributors 30a-30b fulfill orders received from the HHA and/or supplier (via orders 18) and deliver medical equipment or product 50 to the patient or recipient 102. Claims are paid and/or rejected (42) by the payer.

In some instances, the HHA may order from the supplier, such as any of supplier 20a-20n, and the supplier determines a distributor through which to direct the order. When the HHA orders from a supplier, the decision of who to call is in the hands of the clinician. That is, a representative of the HHA may reference a chart on the wall, that says “For insurance company A orders, call supplier 20a. For insurance company B orders call supplier 20n.” This presents the opportunity for error. The nurse or other representative might not have access to all the information/insurance and therefore could make a mistake, and the order is submitted to the wrong party. The consequences are that the wrong party pays for the supplies, therefore overburdening the healthcare system and/or the patient doesn't get the supplies in a timely manner and that compromises their care (possibly costing more money to the system).

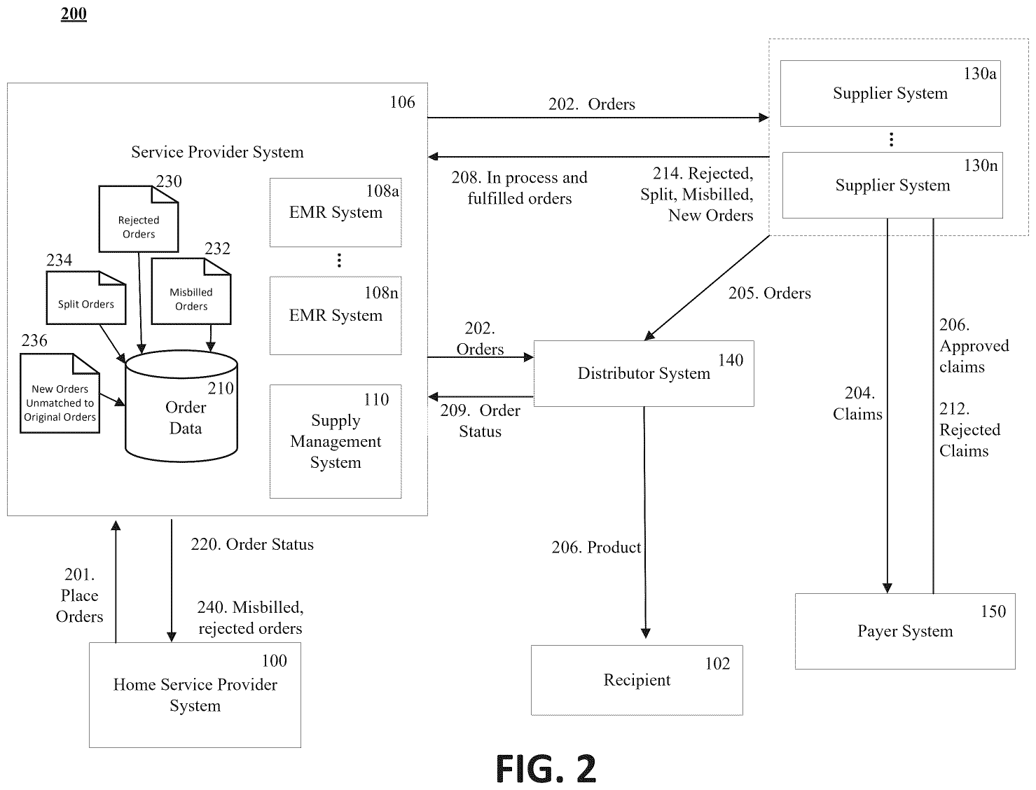

The computer-implemented distributed system of FIG. 2 was implemented at least to address some of the issues described above with respect to FIG. 1. For example, the distributed system of FIG. 2 provides a service provider system 106 that operates at least in part as a portal for HHAs to submit medical supply orders and check order status. The distributed system of FIG. 2 facilitates the submission of such orders to the supplier systems 130a-130n to perform billing processes with the payer system 150, and order forwarding to a distributor system 140. In this regard, the distributed system of FIG. 2, including the service provider system 106, automates at least some aspects of the workflow illustrated in FIG. 1, but by doing so, introduces various technical problems and challenges described in further detail herein.

The service provider system 106 leverages one or more electronic medical record (EMR) systems 108a-108n to automatically incorporate various patient medical data into the medical equipment ordering process. In this regard, a EMR system 108 may maintain patient medical data pertaining to patient information, an electronic health record (EHR), the patient's medical history, diagnoses, insurance information, medications, allergies, immunization history, images, lab results, test results, and/or the like. Some of this data, including personal medical data, is automatically populated into an order for medical supplies such that the data for billing to insurance is automatically provided to other components of the system that utilize such data in their further processing, adjudication, and/or the like. For example, for certain medical billing, personal health information such as diagnoses may be needed, in addition to insurance information and other personal health data such as but not limited to the health data described herein.

The service provider system 106 may further include a supply management system 110 that facilitates the entry of order information for medical equipment, via the home service provider system 100, such as a home service provider system that supports an HHA. For example, a representative of the HHA may access a supply management system 110 directly, and/or via a home service provider system 100 integrated with the service provider system 106 to provide such functionality to representatives of the HHA. In any event, a user accesses a user interface to enter details pertaining to placing an order (201) for medical supplies. The service provider system 106 assembles data from the EMR system 108 and/or supply management system 110 to generate and route an order to a supplier system 130. For example, insurance information and/or wound information included along with information pertaining to the medical equipment order may be submitted (202) to the supplier system 130. Additionally or alternatively to utilizing a user interface provided by the supply management system 110, the service provider system 106 may process a data feed received from one or more systems or subsystems of the home service provider system 100 associated with an HHA, to read the patient-related information and medical supplies order information, apply any pre-processing, and send it to the supplier system 130.

In response to receiving orders from the service provider system 106, the supplier system 130 sends a claim 204), such as an insurance claim, to the payer system 150. Approved claims are paid as directed by the payer system 150, an order is further submitted (205) to the distributor system 140, and the product is distributed (206) to the recipient 102, or patient.

In addition to automating aspects of the workflow of FIG. 1, the distributed system of FIG. 2 provides order statuses by providing responses via the service provider system 106, supply management system 110, and home service provider system 100. The supplier system 130 receives responses regarding approved and/or paid claims (206) from the payer system, and forwards status information (208) regarding in-process and/or fulfilled orders. Similar order statuses may be returned (209) from the distributor system 140. The status information may include shipment and/or billing status related information to the service provider system, as well as identifying information of the order to reconcile with the order data 210. The service provider system 106 may further provide order statuses 220 to the home service provider system 100. In this regard, an order status of medical supply orders can be provided via a user interface, enabling a representative of the HHA to view order status and check the status of an order for medical supplies. In instances that medical supply orders are approved, billed and/or paid, order statuses can be seamlessly provided and accessed by a user, with regard to the patient's information, item number, description of product ordered, expected date of delivery, manufacturer, unit of measure, quantity, and distributor of the product. The distributed system of FIG. 2 therefore provides a technology-implemented solution to certain challenges in the workflow described with respect to FIG. 1.

However, there are several ordering scenarios that when processed by the technology-implemented distributed system of FIG. 2, cause problems at various stages of the order processing and in various components of the distributed system and network. As one example, an order can be misbilled, such as due to routing of an order to the incorrect payer system 150. Misbilling could occur due to outdated or erroneous data stored in one or more of the EMR systems 108a-108n and routed to the supplier system 130. As another example, an order could be rejected as not covered by the payer 150, producing unreconciled data and data objects that require further processing throughout various components of the system. Rejected claims are routed (212) from the payer system 150 to the supplier system 130. In such scenarios of rejected claims and/or misbilled orders, the rejected, cancelled and/or misbilled orders are sent (214) to the service provider system 106. The service provider system 106 stores the rejected orders (230) and misbilled orders (232) and further processes and/or sends them for correction and resubmission. As an example, the service provider system 106 sends rejected and/or misbilled orders (240) to the home service provider system 100. A user of the home service provider system then accesses the rejected and/or misbilled orders, makes corrections, and resubmits the orders. This further processing and communication consumes processing, memory, and network resources at various stages and components of the system, including but not limited to the payer system 150, the supplier system 130, the service provider system 106, and the home service provider system 100.

As another example of a problem occurring in the technology-implemented distributed system of FIG. 2 relates to split orders that occur in response to a payer system 150 covering only part of an order, such as due to only certain items but not other items in the order being covered, or coverage of only a partial quantity of a total quantity of medical supplies ordered (e.g., 30 bandages ordered, but the insurance plan only covers 20 bandages). In a split order scenario, the supplier system 130 returns part of the electronic order as rejected or cancelled. In an instance an order is split into two orders (e.g., a cancelled portion and non-cancelled portion), the quantity is changed on a split order (234) and a new order is generated by the service provider system 106 to cover the remaining quantity. The service provider system 106 generates a new order (236) to replace the portion of the split order not covered, and sends the new order for fulfillment without an insurance claim to be billed to a distributor system 140, through which the medical supplies may be obtained independently of the payer system 150. In this regard, multiple distributors may distribute different quantities of an item to a patient. According to the distributed system of FIG. 2, various technical problems arise from the split order scenario. The newly generated order represents an additional order to be routed and processed throughout various component of the distributed system of FIG. 2, including but not limited to the service provider computer 106, supplier system 130, and distributor system 140, therefore requiring additional computer, memory, and network resources to facilitate the processing of the additional order. The identifying information of the new order does not match the identifying information of the originally submitted order, such as a unique order identifier. The new orders matched to the original orders (236) are therefore omitted when an order status is accessed. When the home service provider system 100 attempts to access the full order history for a patient, the orders may be missing, or only one portion of a split order may be displayed.

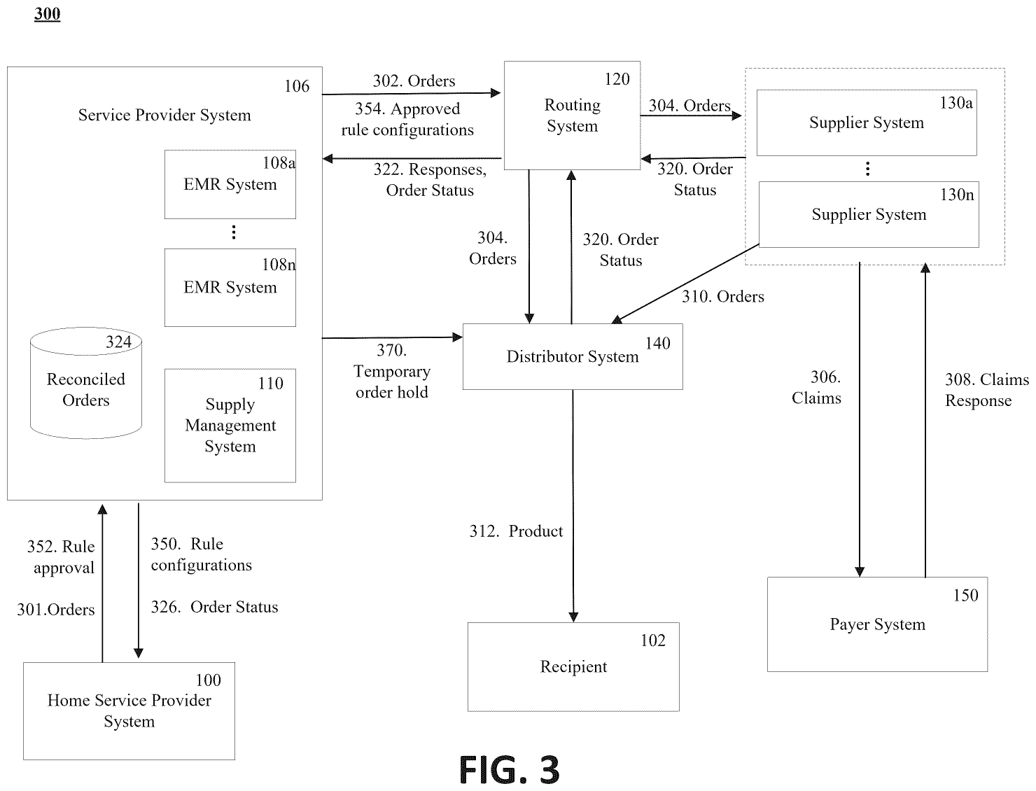

FIG. 3 is a diagram of an improved distributed system 300 according to certain example embodiments provided herein. FIG. 3 illustrates improvements over the distributed system 200 depicted in FIG. 2, as described in further detail herein. A user of a home service provider system 100 accesses a service provider system 106 to initiate orders (301) for home medical equipment and/or supplies. The service provider system 106 facilitates the processing of orders for home medical equipment, provides an electronic medical record (EMR) system 108, and provides a supply management system 110, among other functionality.

The service provider system 106 transmits orders 302 to a routing system 120. The routing system 120 is configured to route orders to the appropriate systems as described in further detail herein, and to separate certain logic and operations regarding such routing from the service provider system 106. The service provider system 106 can therefore devote its computing resources to the provision of the supply management system 110 that interfaces with the home service provider system 100, the application of EMR data from the EMR system 108 to the orders it sends the routing system 120, the reconciliation of orders and order statuses, and other functionality. The service provider system 106 therefore improves the efficiency of the aforementioned functionality of the service provider system 106 by relying on the routing system 120 to route the orders as described herein.

The orders 302 sent to the routing system 120 may include various information pertaining to a patient, the order for medical supplies, wound, diagnosis, physician, home health agency, insurance, and/or the like. For example, an order transmitted from the service provider system 106 to the routing system 120 may include any of following data:
Source
Order Number
Order Date
Order Time
Order Lines
Customer PO Name
Patient Acknowledged
Environment
Episode
Special Instruction 1
Special Instruction 2
Wound ID
Wound Length
Wound Width
Wound Depth
Wound Exudate Amount
Wound Type
Wound Stage
Wound Location Body Part
Wound Location 1
Wound Location 2
Wound Location 3
Wound Location 4
Frequency of Change
Other Attributes
Diagnosis Code
Primary Diagnosis
NPI
Physician Last Name
Physician First Name
Physician Phone Number
Physician Email
Mckesson Account Number
Customer Account Name
Agency Address Line 1
Agency Address Line 2
Agency City
Agency State
Agency Zip Code
User Name
User Phone Number
Clinician Last Name
Clinician First Name
Clinician Address Line 1
Clinician Address Line 2
Clinician Address Line 3
Clinician City
Clinician State
Clinician Zip Code
Clinician Phone Number
Clinician Fax
Clinician Email
Patient ID
Patient Last Name
Patient First Name
Patient Gender
Patient Date of Birth
Patient Address Line 1
Patient Address Line 2
Patient Address Line 3
Patient City
Patient State
Patient Zip Code
Patient Phone Number
Patient Email
Payer ID
Payer Name
Payer Phone Number
Policy Number
Group Number
Policy Holder Relationship to Patient
Insurance COB Hierarchy
Policy Holder Last Name
Policy Holder First Name
Policy Holder Middle Initial
Policy Holder Address Line 1
Policy Holder Address Line 2
Policy Holder Address Line 3
Policy Holder City
Policy Holder State
Policy Holder Zip Code
Policy Holder Date of Birth
Policy Holder Gender
Policy Effective Date
Policy Expiration Date
Customer Order Line Number
McKesson Item Number
Customer Item Number
Manufacturer Item Number
HCPC
Item Description
Order Quantity
Unit of Measure
Ship To

The routing system 120 utilizes a rules engine (described in further detail herein) and a trained machine learning model to predict whether a certain item and/or what quantity thereof will be covered by a patient's insurance plan and route the order accordingly. The machine learning model can be trained with de-identified data received by supplier systems 130, relating to claim remittance by payers such as but not limited to private insurers, Medicare, and/or the like. The machine learning model can further be trained by order data received via the service provider computer 106 pertaining to prior orders placed by an HHA. The machine learning model is further trained over time as the improved distributed system of FIG. 3 is utilized, to adjust for changing insurance policies, coverage, new medical supplies brought to market, changes in distribution, and/or the like.

The routing system 120 uses the rules engine and trained machine learning model to route the order (304) to a supplier system 130 and/or distributor system 140 selected by the routing system 120 based on how the order is predicted to be covered and/or not covered and by what payer. If an item is not expected to be covered by insurance, the associated order is routed to the distributor system 140. If an order is expected to be covered by insurance, the routing system 120 routes the order to a supplier system 130 selected by the routing system 120 and predicted to result in a paid claim and fulfillment of an order. In instances insurance claims are to be submitted, the supplier system 130 submits claims 306) to the applicable payer system 150. Claim responses 308 are returned to the supplier system 130. Due to the inclusion of the routing system 120 in the improved distributed system of FIG. 3, the number of rejected claims is reduced or eliminated accordingly, therefore reducing and/or conserving the processing resources, memory resources, and network resources otherwise expended for the further processing of, and resubmission of related orders in response to rejected claims, and further reducing manual review time that may be needed to provide further input or corrections for order resubmission.

In instances in which orders or partial orders are predicted by the routing system 120 as not covered by insurance, an order may be precluded from billing to a payer system 150 and instead indicated for fulfillment as a wholesale order (which can reduce or limit the number of rejected claims and orders and conserve processing, computer, and network resources otherwise expended on facilitating the communication of such rejected claims). In some instances, the wholesale order is fulfilled by a distributor system 140 that is associated with the service provider system 106, and is further associated with a supplier system 130, such as from an ownership and/or operational perspective. In this regard, including the routing system 120 as an independent router of the medical supply orders and associated claims, alleviates the service provider system 106 from determining which of many supplier systems 130a-130n operative in the network is the appropriate destination for a medical supply order. Accordingly, the processing resources and memory resources otherwise expended by the service provider computer 106 to determine to which supplier system 130 to route an order (see 202 in FIG. 2), are conserved and utilized for other purposes, such as for more efficiently processing inbound orders (301) and performing associated order status tracking and provision of order status to the home service provider system 100 as described in further detail herein.

The supplier system directs the orders (310) to the distributor system 140 such that the product (312) is delivered to a recipient 102, or patient. Order statuses (320) are returned from the supplier system 130 and/or distributor system 140, and responses and order statuses (322) are provided from the routing system 120 to the service provider system 106. The responses sent from the routing system 120 to the service provider system 106 may include any information associating the order with an order sent to the routing system 120, patient information, account information, the distributor information, supplier information, associated statuses, and/or the like.
Account Number
Determined Distributor
Order Number
Patient Address Line 1
Patient Address Line 2
Patient City
Ship To
Patient State
Patient Zip Code
Patient ID
Patient First Name
Patient Last Name
Clinician ID
Clinician First Name
Clinician Last Name
Order number
Episode
Item Number
Total Quantity Ordered
Unit of Measure
Order Received Date
Order Sent to Supplier At
Status
Supplier Status At

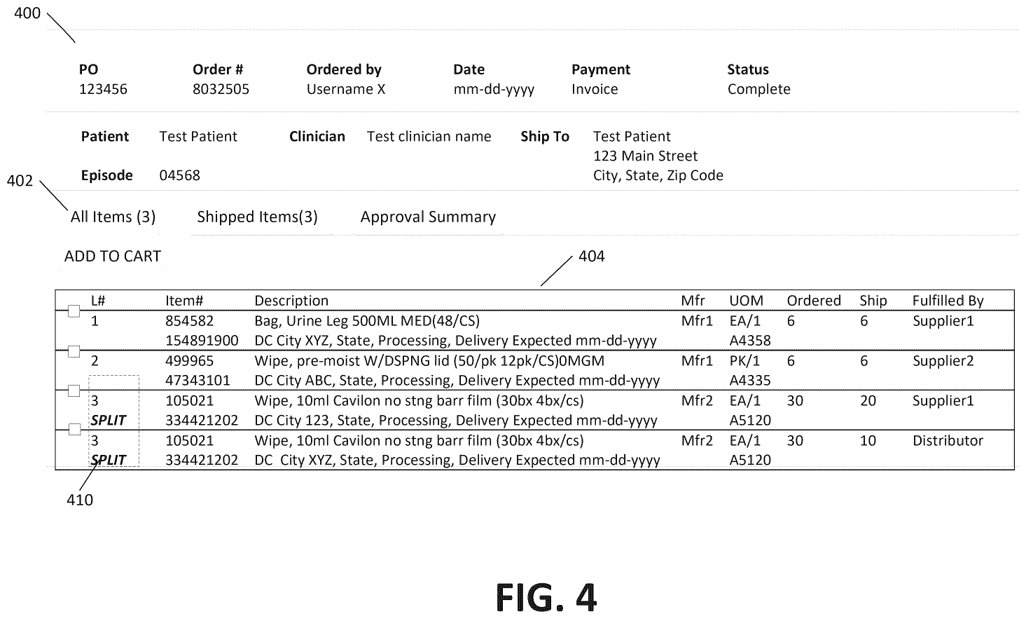

The order statuses received from the routing system 120 are reconciled with the orders originally placed via the service provider system 106, in datastore 324. Utilizing the routing system 120 results in fewer rejected orders, misbilled orders, and split orders that are unmatchable to an original order. Although multiple responses can be returned with a common order line number, example embodiments identify the associated sub-records, which may be referred to as sub-orders, as resulting from a split order such that the supply management system 110 associates them with the original order and provides accurate statuses via the user interface. The order status (326) can therefore be provided by the service provider system 106 to the home service provider system 100 via a user interface for representatives of an HHA to access and review. The home service provider system 100 is therefore improved by receiving the accurate statuses, even for order that have been split, and by providing the accurate statuses, even for orders that have been split, via a user interface such as the example user interface of FIG. 4. Whereas conventional or prior home service provider systems display orders by unique item number or order number, example embodiments disclosed herein improve upon such systems by identifying the split orders and facilitating the home service provider system 100 to accurately display the sub-records belonging to a split electronic record, or split order. According to conventional or prior systems, electronic inquiries may be submitted by users of the home service provider system 100 due to confusion regarding missing suborders or inaccurate quantities caused by an electronic record split. By accurately identifying the sub-records, example embodiments reduce or limit the number of electronic inquiries pertaining to orders, such as those conventionally submitted. The reduction in electronic inquiries results in a reduction in use of computer and network resources that were previously consumed to facilitate the processing of the electronic inquiries. The overall efficiency of the distributed system is therefore also improved.

FIG. 4 is an example user interface that provides order status to users such as users of the home service provider system 100. The user interface may provide order information 400 such as purchase order, order number, user ordered by, date ordered, payment type, status, patient, episode, clinician, and ship to address. The order status may enable filtering (402) by all items of the order, shipped items, and/or an approval summary, including orders that are temporarily on hold for potential modification (described in further detail herein). The order detail 404 includes a line item number, item number, description, manufacturer, units of measure (UOM), ordered quantity, shipping or shipped quantity, and supplier fulfilling the order. The split order 410 shows as two separate line items, despite being associated with the same item number from the order. In the example of FIG. 4, the split order 410 shows one sub-record (e.g., sub-order) as having a quantity of 20 fulfilled by or to be fulfilled by Supplier 1, and a quantity of 10 fulfilled by or to be fulfilled by Distributor. The problem relating to when the home service provider system 100 attempts to access the full order history for a patient, and orders are missing, or only one portion of a split order is displayed, is addressed by accurately identifying the split orders, and indicating the split orders such that they are displayed as a split order as described above and as illustrated in FIG. 4. Each unique electronic order, when considered each field or column, is displayed, rather than only displaying electronic orders for unique item numbers or order numbers, which otherwise would result in a sub-record (e.g., sub-order) not being displayed.

Returning to the description of FIG. 3, the improved distributed system of FIG. 3 enables rule configuration to be performed at least via the service provider system 106, home service provider system 100, and/or routing system 120. A user can enter information defining a rule configuration, such as a payer identifier, payer name, location and/or routing instructions. For example, a rule configuration relating to a certain location, may indicate to send all Medicare orders to Supplier X, all orders for a Commercial Payer X to Supplier Y, all other orders to Supplier X, and/or the like. The rule configurations 350 are sent to the home service provider system 100, and a representative thereof accesses the rule configuration to approve or decline the rule configuration. For example, the user may receive an email with a link to access the rule configuration and select to approve or decline the rule. An indication of rule approval (352) is therefore provided to the service provider system 106 that communicates the approved rule configuration (354) to the routing system 120 to store and reference when processing orders. The routing system 120 can therefore process orders received from the service provider system 106 with regard to the rule configurations to determine a recipient supplier system 130, then further utilizes the machine learning model to determine whether a claim associated with an order directed to the selected supplier system will likely be paid. The routing system 102 can therefore adjust and/or split orders accordingly, and communicate with the service provider system 106 regarding order statuses.

According to certain embodiments, the service provider system 106 may receive responses and/or order statuses (322) indicating a selected distributor system 140 having a predefined configuration and/or relationship with the service provider system 106 to implement temporary order holds for orders that are directed to the distributor system 140 but not via a supplier system 130. The service provider system 106 may indicate to the distributor system 140 that it is placing a temporary order hold (370) on an order, such as for a predetermined amount of time (e.g., 24 hours). The temporary older hold may also be reflected in the order status provided to the home service provider system 100 and may enable a representative or user of the home service provider system 100 to approve or cancel the order. According to certain embodiments, the distributor system 140 may delay providing an order to a distributor system 140 until the predetermined amount of time has passed. Additionally or alternatively, the distributor system 140 holds the order for the predetermined amount of time prior to distributing the order.

The distributed system of FIG. 3 provides several technical advantages and improvements over the distributed system of FIG. 2. A number of cancelled orders and associated reversed insurance claims otherwise generated, such as according to the distributed system of FIG. 2, is reduced and/or limited according to example embodiments. Accordingly, the associated messaging, tracking, and queuing of related messages is also reduced and/or limited, such that the service provider computer 106 the supplier system 140 processes fewer order cancelations and associated tracking, and the payer system 150 receives fewer insurance claims that are ultimately denied, rejected, and/or reversed. The reduction in rejected claims by the payer system 150 further reduces electronic communication generated toward a patient, the home service provider system 100, and/or the like, regarding denied claims. The reduction in rejected claims further leads to a reduction in a queue of the home service provider system 100 of cancelled orders needing review and resubmission, thereby reducing and/or conserving the consumption of memory, and associated processing and network resources, and therefore freeing up such computing resources to facilitate other computer-based processes and tasks more efficiently, such as but not limited to facilitating the ordering of other medical supplies for other patients, and facilitating the electronic and at least partially automated scheduling of resources, having a wide range of experience and expertise, amongst a changing patient population also having varying in-home medical needs and locations.

Additionally, the separation of the service provider system 106 and the routing system 120 in the system of FIG. 3 and according to certain embodiments, provides certain technical advantages. The routing system 120 is configured to determine one or more destinations, such as distributor system 130 and/or the supply management system 110 of the service provider system 106, independently of the service provider system 106 and/or any of its subsystems such as the supply management system 110. The separation of the routing system 120 and the service provider system 106 from a technological infrastructure perspective ensures that the supply management system 110 efficiently processes its own wholesale orders for delivery of medical equipment towards patients and associated communication with the home service provider system 100 and/or patients, without having to facilitate the routing of orders to a plurality of disparate supplier systems 130 operative in the network, each of which may have different messages interfaces and/or formats for such orders. Similarly, the routing system 120 may devote its technology resources to the complex routing of orders to the various supplier systems 130 and/or supply management system 110, each of which may require various interfaces and/or message formats, without having to configure its system to perform fulfillment of orders by supplying medical equipment to patients, and without having to facilitate communication with the home service provider system 100 regarding various errors with orders, insurance claims, and/or the like that may occur within the network.

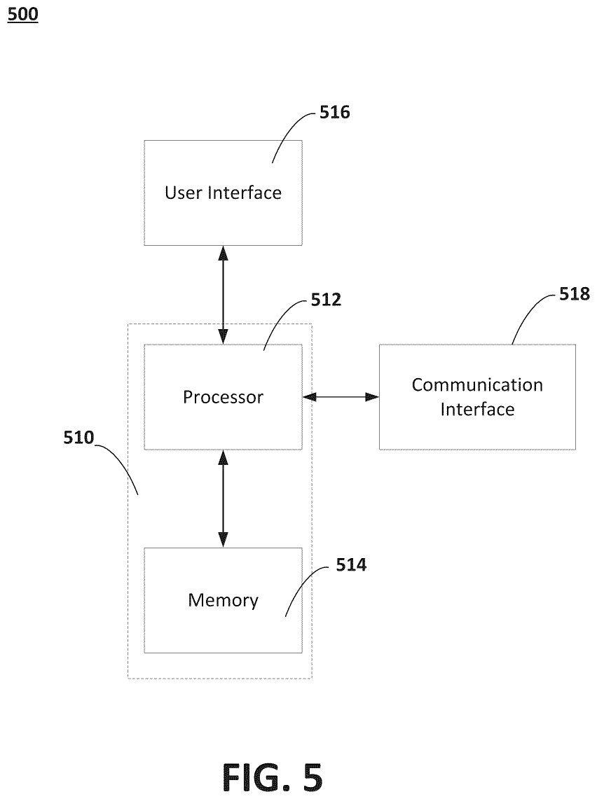

Referring now to FIG. 5, apparatus 500 is a computing device(s) configured for implementing any of the components of the improved distributed system of FIG. 3, such as but not limited to home service provider system 100, service provider system 106, routing system 120, supplier system 130, distributor system 140, payer system 150, and/or the like. Apparatus 500 may at least partially or wholly embody or be embodied by any of the components of FIG. 3. Apparatus 500 may therefore implement any of the components of FIG. 3, in accordance with some example embodiments, or may be implemented as a distributed system that includes any combination of the components, and/or associated network(s).

It should be noted that the components, devices, and elements illustrated in and described with respect to FIG. 5 may not be mandatory and thus some may be omitted in certain embodiments. For example, FIG. 5 illustrates a user interface 516, as described in more detail below, which may be optional in certain devices. Additionally, some embodiments may include further or different components, devices, or elements beyond those illustrated in and described with respect to FIG. 5.

Continuing with FIG. 5, processing circuitry 510 may be configured to perform actions in accordance with one or more example embodiments disclosed herein. In this regard, the processing circuitry 510 may be configured to perform and/or control performance of one or more functionalities of apparatus 500 in accordance with various example embodiments. The processing circuitry 510 may be configured to perform data processing, application execution, and/or other processing and management services according to one or more example embodiments. In some embodiments apparatus 500, or a portion(s) or component(s) thereof, such as the processing circuitry 510, may be embodied as or comprise a circuit chip. The circuit chip may constitute means for performing one or more operations for providing the functionalities described herein.

In some example embodiments, the processing circuitry 510 may include a processor 512, and in some embodiments, such as that illustrated in FIG. 5, may further include memory 514. The processing circuitry 510 may be in communication with or otherwise control a user interface 516, and/or a communication interface 518. As such, the processing circuitry 510, such as that included in any of the service provider system 106, and/or other apparatus 500 may be embodied as a circuit chip (e.g., an integrated circuit chip) configured (e.g., with hardware, software, or a combination of hardware and software) to perform operations described herein.

The processor 512 may be embodied in a number of different ways. For example, the processor 512 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 512 may comprise a plurality of processors. The plurality of processors may be in operative communication with each other and may be collectively configured to perform one or more functionalities of apparatus 500 as described herein. The plurality of processors may be embodied on a single computing device or distributed across a plurality of computing devices collectively configured to function as the service provider system 106 and/or apparatus 500. In some example embodiments, the processor 512 may be configured to execute instructions stored in the memory 514 or otherwise accessible to the processor 512. As such, whether configured by hardware or by a combination of hardware and software, the processor 512 may represent an entity (e.g., physically embodied in circuitry—in the form of processing circuitry 510) capable of performing operations according to embodiments of the present disclosure while configured accordingly. Thus, for example, when the processor 512 is embodied as an ASIC, FPGA, or the like, the processor 512 may be specifically configured hardware for conducting the operations described herein. Alternatively, as another example, when the processor 512 is embodied as an executor of software instructions, the instructions may specifically configure the processor 512 to perform one or more operations described herein.

In some example embodiments, the memory 514 may include one or more non-transitory memory devices such as, for example, volatile and/or non-volatile memory that may be either fixed or removable. In this regard, the memory 514 may comprise a non-transitory computer-readable storage medium. It will be appreciated that while the memory 514 is illustrated as a single memory, the memory 514 may comprise a plurality of memories. The plurality of memories may be embodied on a single computing device or may be distributed across a plurality of computing devices. The memory 514 may be configured to store information, data, applications, computer program code, instructions and/or the like for enabling apparatus 500 to carry out various functions in accordance with one or more example embodiments. For example, when apparatus 500 is implemented as service provider computer 106, memory 514 may be configured to store computer program code for performing corresponding functions thereof, as described herein according to example embodiments.

Still further, memory 514 may further include a database, reconciliation tables, and/or reconciled orders 324, enabling provision of reconciled order statuses. The memory 514 may be further configured to buffer input data for processing by the processor 512. Additionally or alternatively, the memory 514 may be configured to store instructions for execution by the processor 512. In some embodiments, the memory 514 may include one or more databases that may store a variety of files, content, or data sets. Among the contents of the memory 514, applications may be stored for execution by the processor 512 to carry out the functionality associated with each respective application. In some cases, the memory 514 may be in communication with one or more of the processor 512, user interface 516, and/or communication interface 518, for passing information among components of apparatus 500.

The optional user interface 516 may be in communication with the processing circuitry 510 to receive an indication of a user input at the user interface 516 and/or to provide an audible, visual, mechanical, or other output to the user. As such, the user interface 516 may include, for example, a keyboard, a mouse, a display, a touch screen display, a microphone, a speaker, and/or other input/output mechanisms. As such, in embodiments, in some example embodiments, provide means for user entry of order information, and/or the like. The user interface 516 may be further configured to display or provide order statuses regarding such orders. In some example embodiments, aspects of user interface 516 may be limited or the user interface 516 may not be present.

The communication interface 518 may include one or more interface mechanisms for enabling communication with other devices and/or networks. In some cases, the communication interface 518 may be any means such as a device or circuitry embodied in either hardware, or a combination of hardware and software that is configured to receive and/or transmit data from/to a network and/or any other device or module in communication with the processing circuitry 510. By way of example, the communication interface 518 may be configured to enable communication over a network, amongst any of the components of the improved distributed system of FIG. 3, including various instances of apparatus 500. Accordingly, the communication interface 518 may, for example, include supporting hardware and/or software for enabling wireless and/or wireline communications via cable, digital subscriber line (DSL), universal serial bus (USB), Ethernet, or other methods.

A network, such as the network in which the systems of FIG. 3 or components thereof or components described herein may operate, may include a local area network, the Internet, any other form of a network, or any combination thereof, including proprietary private and semi-private networks and public networks. The network may comprise a wired network and/or a wireless network (e.g., a cellular network, wireless local area network, wireless wide area network, some combination thereof, and/or the like).

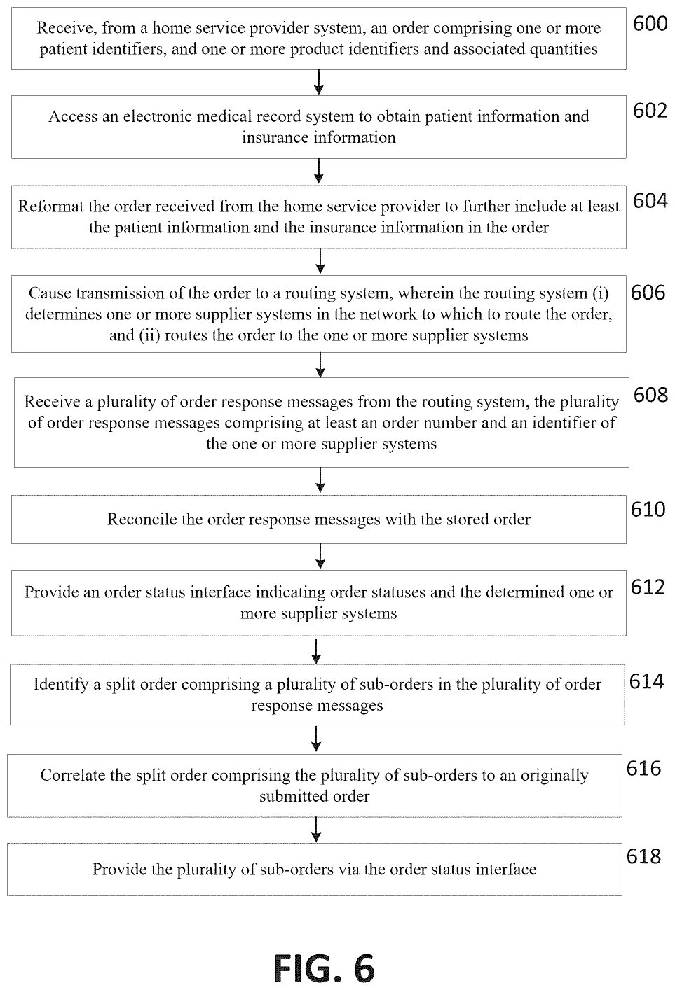

Having now described the apparatus 500 that implements components of the improved distributed system, FIG. 6 is a flowchart of operations that may be performed by apparatus 500, such as the service provider system 106, according to certain embodiments. As shown by operation 600, the service provider system 106, such as apparatus 500, includes means, such as processor 512, memory 514, user interface 516, communication interface 518, and/or the like, for receiving, from a first system of a first type, such as home service provider system 100, an order comprising one or more patient identifiers, and one or more product identifiers and associated quantities. See for example operation 301 of FIG. 3. A user of the home service provider system 100 may initiate an order for medical supplies using a user interface provided by the service provider system 106, such as with the supply management system 110.

As shown by operation 602, the service provider system 106, such as apparatus 500, includes means, such as processor 512, memory 514, user interface 516, communication interface 518, and/or the like, for accessing an electronic medical record system to obtain patient information and insurance information. In this regard, the EMR system 108 of the service provider system 106 may access data pertaining to the patient's EMR such as but not limited to the patient's medical history, diagnoses, insurance information, medications, allergies, immunization history, images, lab results, test results, and/or the like.

As shown by operation 604, the service provider system 106, such as apparatus 500, includes means, such as processor 512, memory 514, user interface 516, communication interface 518, and/or the like, for reformatting the order received from the home service provider to further include at least the patient information and the insurance information in the order. The service provider system 106 uses the information obtained from the EMR system 108 to include in a data object representative of the order such that the order sent from the service provider system 106 provides additional detail beyond the order information provided by the user, and/or home service provider system 100. Implementing the order submission in a computer environment enables efficient reformatting of the order to include a wide range of data available in a patient's EMR.

As shown by operation 606, the service provider system 106, such as apparatus 500, includes means, such as processor 512, memory 514, communication interface 518, and/or the like, for causing transmission of the order to a routing system, wherein the routing system (i) determines one or more supplier systems in the network to which to route the order, and (ii) routes the order to the one or more supplier systems. As described herein, the routing system 120 utilizes a machine learning model and/or rules engine configured with rules provided by the service provider system 106 to determine the supplier system to which to route an order. For example, the routing system may route the order to a supplier system determined as most likely to result in the order converting to a paid claim by a payer.

As shown by operation 608, the service provider system 106, such as apparatus 500, includes means, such as processor 512, memory 514, communication interface 518, and/or the like, for receiving a plurality of electronic record response messages, such as order response messages, from the routing system, the plurality of electronic record response messages comprising at least an order number and an identifier of the one or more supplier systems. The electronic response messages, otherwise referred to as order response messages are provided by the routing system, such as for example as illustrated by operation 322 of FIG. 3.

As shown by operation 610, the service provider system 106, such as apparatus 500, includes means, such as processor 512, memory 514, communication interface 518, and/or the like, for reconciling the electronic record response messages with the stored orders, for example, as shown by the reconciled orders 324 of FIG. 4. As described herein, by utilizing the routing system 120 to route the orders to a selected supplier system 130, the number of rejected claims, rejected orders, and misbilled orders can be reduced or minimized, therefore improving the service provider system and other components of the distributed system by reducing consumption of processing resources, memory resources, network resources and/or the like.

As shown by operation 612, the service provider system 106, such as apparatus 500, includes means, such as processor 512, memory 514, user interface 516, communication interface 518, and/or the like, for providing an order status interface indicating order statuses and the determined one or more supplier systems. For example, see operation 220 of FIG. 2 and the example user interface of FIG. 4.

As shown by operation 614, the service provider system 106, such as apparatus 500, includes means, such as processor 512, memory 514, communication interface 518, and/or the like, for identifying a split order comprising a plurality of sub-orders in the plurality of electronic record response messages. As shown by operation 616, the service provider system 106, such as apparatus 500, includes means, such as processor 512, memory 514, communication interface 518, and/or the like, for correlating the split order comprising the plurality of sub-orders to an originally submitted order. As shown by operation 618, the service provider system 106, such as apparatus 500, includes means, such as processor 512, memory 514, communication interface 518, and/or the like, for providing the plurality of sub-orders via the order status interface. Example embodiments, such as the service provider system 106, and/or supply management system 110, indicate in the order status interface at least two sub-orders associated with a single product, wherein the quantities of the at least two sub-orders equal a quantity ordered of the single product. Different supplier systems and/or a distributor system may be selected for each of at least two sub-orders based on a determination of a limited quantity of the product covered by insurance. As shown in FIG. 4, one example of a split order includes 2 sub-orders, or line items, correlating to an item number 105021. One sub-order includes a quantity of 20 from Supplier1, and a quantity of 10 ordered via a Distributor, that when combined equals the total quantity, 30, submitted with the original order. Utilization of the routing system 120 that provides splits orders returned with an original order number, reduces the number of new orders that are unmatched to their corresponding orders in the service provider system 106, therefore improving the reconciliation of orders by the service provider system 106, and enabling the provision of more accurate order statuses, such as illustrated in the example user interface of FIG. 4.

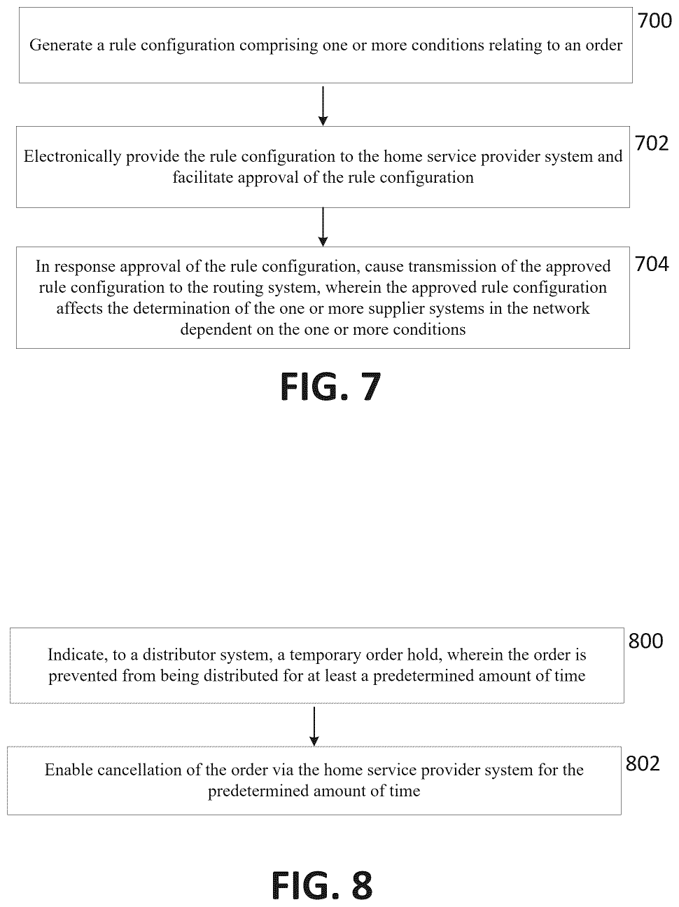

FIG. 7 is a flowchart of operations that may be performed by apparatus 500, such as the service provider system 106, according to certain embodiments. As shown by operation 700, the service provider system 106, such as apparatus 500, includes means, such as processor 512, memory 514, user interface 516, communication interface 518, and/or the like, for generating a rule configuration comprising one or more conditions relating to an order. As shown by operation 702, the service provider system 106, such as apparatus 500, includes means, such as processor 512, memory 514, communication interface 518, and/or the like, for electronically providing the rule configuration from the routing system 120 to the home service provider system and facilitate approval of the rule configuration. See at least operation 350 of FIG. 3. As shown by operation 704, the service provider system 106, such as apparatus 500, includes means, such as processor 512, memory 514, user interface 516, communication interface 518, and/or the like, for in response to approval of the rule configuration, causing transmission of the approved rule configuration to the routing system, wherein the approved rule configuration affects the determination of the one or more supplier systems in the network dependent on the one or more conditions. As an example, a rule can indicate that orders originating from a certain home service provider system 100 are to be routed to a particular supplier system based on certain predefined insurance information associated with the patient is included in the order.

FIG. 8 is a flowchart of operations that may be performed by apparatus 500, such as the service provider system 106, according to certain embodiments. As shown by operation 800, the service provider system 106, such as apparatus 500, includes means, such as processor 512, memory 514, communication interface 518, and/or the like, for indicating, to a distributor system, a temporary order hold, wherein the order is prevented from being forwarded for distribution, or prevented from being distributed, for at least a predetermined amount of time. See at least operation 370 of FIG. 3. Temporarily holding an order is a nonconventional operation in comparison to conventional systems which forwarded or submitted orders as soon as possible in order to have orders distributed as quickly as possible. Temporarily holding an electronic record, or order, allows for modification or cancellation prior to actual distribution, and improves certain components of the distributed system, such as the distributor system 140, supplier system 130, routing system 120, service provider system 106, home service provider system 100, and the like. Temporarily holding an order and preventing it from being forwarded for distribution, or distributed for at least a predetermine amount of time, allows for cancellation or modification earlier in a process, and reduces the instances of electronic orders throughout other components of the distributed system that need to be cancelled or modified at a later stage, therefore reducing the consumption of computing resources and network resources, and improving the efficiency of certain systems, and efficiency of the overall distributed system. The overall efficiency may be improved by reducing the number of instances of electronic records needing modification or cancelation throughout different components of the distributed system.

As shown by operation 802, the service provider system 106, such as apparatus 500, includes means, such as processor 512, memory 514, user interface 516, communication interface 518, and/or the like, for enabling cancellation of the order, via at least the supply management system 110, for the predetermined amount of time, such as accessing an order status and indicating to cancel the order during the temporary hold period.

FIGS. 3-8 illustrate operations of a method, apparatus, and computer program product according to some example embodiments. It will be understood that each operation of the flowchart or diagrams, and combinations of operations in the flowchart or diagrams, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, memory 514) storing instructions executable by a processor in the computing device (for example, by processor 512). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, apparatus 500) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, apparatus 500 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the at least one processor, cause the apparatus to at least:
receive, from a first system of a first type, an electronic record comprising one or more first entity identifiers, and one or more product identifiers and associated quantities;
access an electronic record system to obtain first entity information and second entity information;
reformat the electronic record to further include at least the first entity information and the second entity information in the electronic record;
cause transmission of the electronic record to a routing system, wherein the routing system (i) determines one or more systems of a second type to which to route the electronic record, and (ii) routes the electronic record to the one or more systems of a second type;
receive a plurality of electronic record response messages from the routing system, the plurality of electronic record response messages comprising at least an electronic record number and an identifier of the one or more systems of a second type;
reconcile the plurality of electronic record response messages with the received electronic record;
provide an electronic record status interface indicating electronic records statuses and the determined one or more systems of a second type;
identify a split electronic record comprising a plurality of sub-records in the plurality of electronic record response messages;
correlate the split electronic record comprising the plurality of sub-records to an originally submitted electronic record; and
provide the plurality of sub-records via the electronic record status interface.

2. The apparatus according to claim 1, wherein the at least one memory and the computer program code are further configured to, with the at least one processor, cause the apparatus to at least:
generate a rule configuration comprising one or more conditions relating to an electronic record;
electronically provide the rule configuration to the first system and facilitate approval of the rule configuration; and
in response approval of the rule configuration, cause transmission of the approved rule configuration to the routing system, wherein the approved rule configuration affects the determination of the one or more systems of a second type dependent on the one or more conditions.

3. The apparatus according to claim 1, wherein the at least one memory and the computer program code are further configured to, with the at least one processor, cause the apparatus to at least:
indicate, to a system of a third type, a temporary electronic record hold, wherein the electronic record is prevented from being distributed for at least a predetermined amount of time; and
enable cancellation of the electronic record via, at least a supply management system, for the predetermined amount of time.

4. The apparatus according to claim 1, wherein the at least one memory and the computer program code are further configured to, with the at least one processor, cause the apparatus to at least:
determine at least one sub-record of the split electronic records is cancelled, and in response thereto, generate a new electronic record comprising a quantity based on one or more non-cancelled electronic records.

5. The apparatus according to claim 4, wherein the at least one memory and the computer program code are further configured to, with the at least one processor, cause the apparatus to at least:
indicate in the electronic record status interface at least two sub-records associated with a single product, wherein quantities of the at least two sub-records equal a quantity electronic recorded of the single product.

6. The apparatus according to claim 4, wherein different systems of a second type are selected for each of at least two electronic records based on a determination of a limited quantity of a product covered by second entity.

7. A method comprising:
receiving, from a first system of a first type, an electronic record comprising one or more first entity identifiers, and one or more product identifiers and associated quantities;
accessing an electronic record system to obtain first entity information and second entity information;
with one or more processors, reformatting the electronic record to further include at least the first entity information and the second entity information in the electronic record;
causing transmission of the electronic record to a routing system, wherein the routing system (i) determines one or more systems of a second type to which to route the electronic record, and (ii) routes the electronic record to the one or more systems of a second type;
receiving a plurality of electronic record response messages from the routing system, the plurality of electronic record response messages comprising at least an electronic record number and an identifier of the one or more systems of a second type;
reconciling the plurality of electronic record response messages with the received electronic record;
providing an electronic record status interface indicating electronic record statuses and the determined one or more systems of a second type;
identifying a split electronic record comprising a plurality of sub-records in the plurality of electronic record response messages;
correlating the split electronic record comprising the plurality of sub-records to an originally submitted electronic record; and
providing the plurality of sub-records via the electronic record status interface.

8. The method according to claim 7, further comprising:
generating a rule configuration comprising one or more conditions relating to an electronic record;
electronically providing the rule configuration to the first system and facilitate approval of the rule configuration; and
in response approval of the rule configuration, causing transmission of the approved rule configuration to the routing system, wherein the approved rule configuration affects the determination of the one or more systems of a second type dependent on the one or more conditions.

9. The method according to claim 7, further comprising:
indicating, to a system of a third type, a temporary electronic record hold, wherein the electronic record is prevented from being distributed for at least a predetermined amount of time; and
enable cancellation of the electronic record, via at least a supply management system, for the predetermined amount of time.

10. The method according to claim 7, further comprising:
determining at least one sub-record of the split electronic records is cancelled, and in response thereto, generate a new electronic record comprising a quantity based on one or more non-cancelled electronic records.

11. The method according to claim 10, further comprising:
indicating in the electronic record status interface at least two sub-records associated with a single product, wherein quantities of the at least two sub-records equal a quantity electronic recorded of the single product.

12. The method according to claim 10, wherein different systems of a second type are selected for each of at least two electronic records based on a determination of a limited quantity of a product covered by second entity.

13. A computer program product comprising at least one non-transitory computer-readable storage medium having computer-executable program code instructions stored therein, the computer-executable program code instructions comprising program code instructions to:
receive, from a first system of a first type, an electronic record comprising one or more first entity identifiers, and one or more product identifiers and associated quantities;
access an electronic record system to obtain first entity information and second entity information;
reformat the electronic record to further include at least the first entity information and the second entity information in the electronic record;
cause transmission of the electronic record to a routing system, wherein the routing system (i) determines one or more systems of a second type to which to route the electronic record, and (ii) routes the electronic record to the one or more systems of a second type;
receive a plurality of electronic record response messages from the routing system, the plurality of electronic record response messages comprising at least an electronic record number and an identifier of the one or more systems of a second type;
reconcile the plurality of electronic record response messages with the received electronic record;
provide an electronic record status interface indicating electronic record statuses and the determined one or more systems of a second type;
identify a split electronic record comprising a plurality of sub-records in the plurality of electronic record response messages;
correlate the split electronic record comprising the plurality of sub-records to an originally submitted electronic record; and
provide the plurality of sub-records via the electronic record status interface.

14. The computer program product according to claim 13, wherein the computer-executable program code instructions further comprise program code instructions to:
generate a rule configuration comprising one or more conditions relating to an electronic record;
electronically provide the rule configuration to the first system and facilitate approval of the rule configuration; and
in response approval of the rule configuration, cause transmission of the approved rule configuration to the routing system, wherein the approved rule configuration affects the determination of the one or more systems of a second type dependent on the one or more conditions.

15. The computer program product according to claim 13, wherein the computer-executable program code instructions further comprise program code instructions to:
indicate, to a system of a third type, a temporary electronic record hold, wherein the electronic record is prevented from being distributed for at least a predetermined amount of time; and
enable cancellation of the electronic record via, at least a supply management system, for the predetermined amount of time.

16. The computer program product according to claim 13, wherein the computer-executable program code instructions further comprise program code instructions to:
determine at least one sub-record of the split electronic records is cancelled, and in response thereto, generate a new electronic record comprising a quantity based on one or more non-cancelled electronic records.

17. The computer program product according to claim 16, wherein the computer-executable program code instructions further comprise program code instructions to:
indicate in the electronic record status interface at least two sub-records associated with a single product, wherein quantities of the at least two sub-records equal a quantity electronic recorded of the single product.

18. The computer program product according to claim 16, wherein different systems of a second type are selected for each of at least two electronic records based on a determination of a limited quantity of a product covered by second entity.
